(19) United States
(12) Patent Application Publication
(10) Pub. No.: US 2024/0339858 A1
(43) Pub. Date: Oct. 10, 2024

(54) SYSTEM AND METHOD FOR SETTING CURRENT CAPACITY OF A CHARGING CABLE FOR SUPPLY OF BATTERY POWER FROM ONE ELECTRIC VEHICLE TO ANOTHER ELECTRIC VEHICLE

(71) Applicants: HYUNDAI MOTOR COMPANY, Seoul (KR); KIA CORPORATION, Seoul (KR)

(72) Inventors: Byeong Seob Song, Suwon-si (KR); Jae Hyuk Choi, Seoul (KR); Bo Kyung Yoon, Incheon (KR); Hae Seung Lee, Yongin-si (KR); Ho Young Jung, Hwaseong-si (KR)

(73) Assignees: HYUNDAI MOTOR COMPANY, Seoul (KR); KIA CORPORATION, Seoul (KR)

(21) Appl. No.: 18/374,984

(22) Filed: Sep. 29, 2023

(30) Foreign Application Priority Data
Apr. 6, 2023 (KR) 10-2023-0045133

(51) Int. Cl. H02J 7/34; B60L 53/18; H02J 7/00

(52) U.S. Cl. CPC H02J 7/342; B60L 53/18; H02J 7/0047; H02J 7/0068

(57) ABSTRACT

In a system for setting current capacity of a charging cable for supply of battery power from one electric vehicle to another electric vehicle, a discharge controller is provided in a supply vehicle to discharge a battery of the supply vehicle to supply battery power to a target vehicle. A charge controller is provided in the target vehicle to charge a battery of the target vehicle with battery power supplied from the supply vehicle. A charging cable part electrically connects the supply vehicle and the target vehicle. The discharge controller is configured to perform control so that a discharging current of the charging cable part is set by detecting an allowable charging current of the charging cable part connected to the supply vehicle and comparing the allowable charging current with a predetermined maximum current outputtable from the supply vehicle.

### CROSS REFERENCE TO RELATED APPLICATION

The present application claims the benefit of and priority to Korean Patent Application No. 10-2023-0045133, filed Apr. 6, 2023, the entire contents of which are incorporated herein by reference.

### TECHNICAL FIELD

The present disclosure generally relates to a system and methods for setting current capacity of a charging cable for supply of battery power from one electric vehicle to another electric vehicle, and more particularly, to a system and methods that allow a consumer to safely use a charging cable having desired specification.

### BACKGROUND

Recently, electric vehicles using electricity, which is pollution-free energy, as a power source have been commercialized, and research on electric vehicles is actively underway. Such an electric vehicle is typically supplied with commercial power that is converted into DC power to charge the battery. The motor of the electric vehicle is driven by the voltage charged in the battery to propel the vehicle.

In an electric vehicle, the motor must be driven with a voltage charged in the battery. Due to the limited battery capacity, the driving distance is short, and the battery must be charged frequently compared to a vehicle that uses petroleum fuel to fuel an engine.

Since there is a shortage of charging equipment for charging electric vehicles, it is very difficult to find and move to a place where charging facilities are provided when the battery power of an electric vehicle is insufficient during driving.

Therefore, when an emergency situation arises in which the electric vehicle stops on the road due to battery discharge, there are problems in that the driving of the electric vehicle is impossible and an accident with another vehicle on the road may occur.

In addition, electric vehicles cannot charge battery power unless electric vehicles are provided with charging equipment. Thus, even in the case in which an electric vehicle with sufficiently charged battery power is present around an electric vehicle the battery of which is discharged, there is a problem in that supply of battery power is fundamentally impossible.

Accordingly, it is desired to expand charging infrastructure such as charging facilities in order to increase the distribution of electric vehicles. In addition, it is desired to develop a technology by which when an emergency of battery discharge occurs in an electric vehicle, the electric vehicle may receive battery power from another electric vehicle in which the battery is sufficiently charged.

The foregoing is intended merely to aid in the understanding of the background of the present disclosure, and is not intended to mean that the present disclosure falls within the purview of the related art that is already known to those having ordinary skill in the art.

### SUMMARY

Accordingly, the present disclosure has been made keeping in mind the above problems occurring in the related art. Embodiments of the present disclosure provide a system and a method for setting current capacity of a charging cable for supply of battery power from one electric vehicle to another electric vehicle. In embodiments of the present disclosure, control is performed by comparing the maximum current outputtable from the supply vehicle and the allowable charging current of the charging cable that is calculated during slow or fast charging, so that the discharging current is limited to a smaller one of the maximum current and the allowable charging current. Thus, the current capacity of the charging cable is appropriately limited. During the supply of battery power from one electric vehicle to another electric vehicle, a fire or the like may be prevented, thereby improving safety. In addition, it is not required to manually set current capacity of the charging cable. Accordingly, convenience may be provided.

According to an embodiment of the present disclosure, a system for setting current capacity of a charging cable for supply of battery power from one electric vehicle to another electric vehicle is provided. The system may include a discharge controller provided in a supply vehicle to discharge a battery of a supply vehicle to supply battery power to a target vehicle. The system may also include a charge controller provided in the target vehicle to charge a battery of the target vehicle with battery power supplied from the supply vehicle. The system may further include a charging cable part configured to electrically connect the supply vehicle and the target vehicle. The discharge controller may be configured to perform control so that a discharging current of the charging cable part is set by detecting an allowable charging current of the charging cable part connected to the supply vehicle and comparing the allowable charging current with a predetermined maximum current outputtable from the supply vehicle.

The discharge controller may be configured to perform control so that a smaller one of the allowable charging current and the maximum current is set as the discharging current.

The discharge controller may be configured to measure a voltage applied to a resistor inserted into a first connector of the charging cable part connected to the supply vehicle and detect the allowable charging current using the measured voltage.

The discharge controller may be configured to apply the measured voltage to an output table including a plurality of minimum voltage ranges and a plurality of maximum voltage ranges and compare the allowable charging current converted according to the measured voltage with the maximum current.

The allowable charging current according to the plurality of minimum and maximum voltage ranges may be converted and stored in the output table.

The allowable charging current according to the measured voltage, converted differently according to slow charging or fast charging, may be stored in the output table. When fast charging is selected in response to a user input, the discharge controller may apply the measured voltage to a corresponding output table and compare the allowable charging current converted according to the measured voltage with the maximum current.

The charging cable part may include a first connector connected to an inlet of the supply vehicle, a second connector connected to an inlet of the target vehicle, and a connection cable connecting the first connector and the second connector to each other.

According to another embodiment of the present disclosure, a system for setting current capacity of a charging cable for supply of battery power from one electric vehicle to another electric vehicle is provided. The system may include a charging cable part including a first connector for discharging of a battery and a second connector for charging of the battery. The charging cable part may be configured to electrically connect vehicles. The system may also include a charge-discharge controller configured to perform control so that a discharging current of the charging cable part to be supplied through the second connector is set by detecting an allowable charging current of the charging cable part connected to the first connector and by comparing the allowable charging current with a predetermined maximum current outputtable from the first connector.

The charge-discharge controller may be configured to set the discharging current to be limited to a smaller one of the allowable charging current and the maximum current.

The charge-discharge controller and the battery may be provided in each of the vehicles.

The charging cable part may be configured such that a resistor is selectively inserted into the first connector. The charge-discharge controller may be configured to measure a voltage applied to the resistor inserted into the first connector and detect the allowable charging current through the measured voltage.

According to yet another embodiment of the present disclosure, a method of setting current capacity of a charging cable for supply of battery power from one electric vehicle to another electric vehicle is provided. The method may include electrically connecting a supply vehicle supposed to supply battery power and a target vehicle supposed to receive the battery power using a charging cable part. The method may also include, when the charging cable part is connected to the supply vehicle, detecting an allowable charging current of the charging cable part connected to the supply vehicle through a discharging controller. The method may further include setting a discharging current of the charging cable part by comparing the allowable charging current and a predetermined maximum current outputtable from the supply vehicle using the discharging controller. The method may additionally include discharging the battery of the supply vehicle according to the discharging current to supply the battery power to the target vehicle. The method may further still include charging a battery of the target vehicle using the battery power of the discharging current supplied from the supply vehicle.

Setting the discharging current of the charging cable part may include setting, by the discharging controller, the discharging current to be limited to a smaller one among the allowable charging current and the maximum current.

Setting the discharging current of the charging cable part may include measuring, the discharging controller, a voltage applied to the first connector of the charging cable part connected to the supply vehicle and detecting, by the discharging controller, the allowable charging current through the measured voltage.

Setting the discharging current of the charging cable part may include applying, by the discharging controller, the measured voltage to an output table including a plurality of minimum voltage ranges and a plurality of maximum voltage ranges and comparing the allowable charging current converted according to the measured voltage with the maximum current.

The allowable charging current according to the plurality of minimum and maximum voltage ranges may be converted and stored in the output table.

The allowable charging current according to the measured voltage, converted differently according to slow charging or fast charging, may be stored in the output table. Setting the discharging current of the charging cable part may include, when fast charging is selected in response to a user input, applying, by the discharging controller, the measured voltage to the corresponding output table and comparing the allowable charging current converted according to the measured voltage with the maximum current.

According to embodiments of the present disclosure, control is performed by comparing the maximum current outputtable from the supply vehicle and the allowable charging current of the charging cable part calculated during slow or fast charging so that the discharging current is limited to a smaller one among the maximum current and the allowable charging current. Thus, the current capacity of the charging cable is appropriately limited. During the supply of battery power from one electric vehicle to another electric vehicle, a fire or the like may be prevented, thereby improving safety. In addition, it is not required to manually set current capacity of the charging cable. Accordingly, convenience may be provided.

Accordingly, according to embodiments of the present disclosure, it is not necessary to use a charging cable having the maximum discharge current for safety reasons, and there is an effect of allowing consumers to select a charging cable having desired current capacity in consideration of weight, price, and the like of the charging cable.

In addition, embodiments of the present disclosure provide convenience because charging control is performed by determining the allowable current capacity of the charging cable connected to the supply vehicle and comparing the allowable current capacity with the allowable current of the charging cable.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a diagram illustrating a system for setting current capacity of a charging cable for supply of battery power from one electric vehicle to another electric vehicle, according to embodiments of the present disclosure;

FIG. 2 is a diagram illustrating a circuit configuration of a system for setting current capacity of a charging cable for supply of battery power from one electric vehicle to another electric vehicle, according to an embodiment of the present disclosure;

FIG. 3 is a diagram illustrating a circuit configuration of a system for setting current capacity of a charging cable for supply of battery power from one electric vehicle to another electric vehicle, according to another embodiment of the present disclosure;

FIG. 4 is a diagram illustrating a circuit configuration of the system for setting current capacity of a charging cable for supply of battery power from one electric vehicle to another electric vehicle, according to yet another embodiment of the present disclosure; and

FIG. 5 is a flowchart illustrating a method of setting current capacity of a charging cable for supply of battery power from one electric vehicle to another electric vehicle, according to embodiments of the present disclosure.

### DETAILED DESCRIPTION

Hereinafter, embodiments of the present disclosure are described in detail with reference to the accompanying drawings.

The above and other advantages and features of the present disclosure, as well as methods for realizing the same, should be more clearly understood from the following detailed description of embodiments when taken in conjunction with the accompanying drawings.

However, the present disclosure is not limited to specific embodiments described hereinafter but may be embodied in a variety of different forms. The embodiments are provided so that the description of the present disclosure is complete and fully conveys the scope of the present disclosure to those having ordinary skill in the art to which the present disclosure pertains. The present disclosure is defined by the scope of the appended claims.

In the following description, a detailed description of known technology or the like has been omitted in situations in which the subject matter of the present disclosure may be obscured thereby.

When a component, device, element, or the like of the present disclosure is described as having a purpose or performing an operation, function, or the like, the component, device, or element should be considered herein as being “configured to” meet that purpose or perform that operation or function.

The term “controller” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

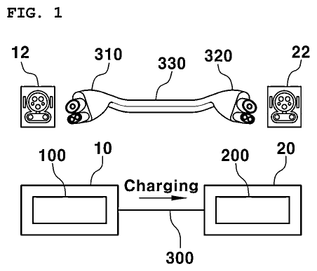

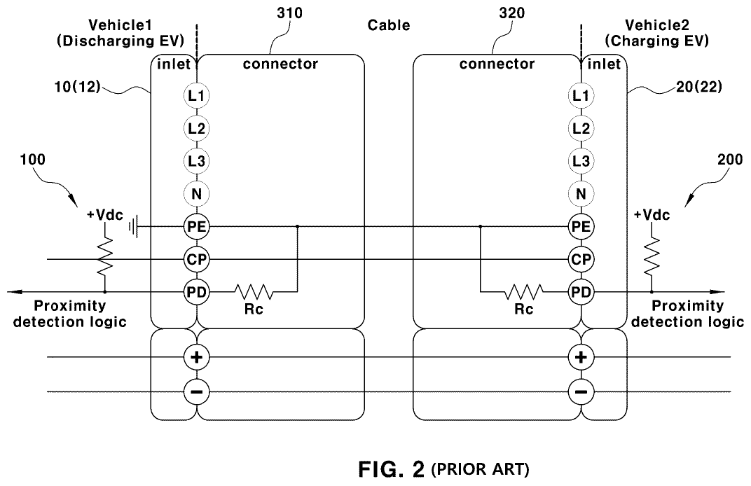

FIG. 1 is a diagram illustrating a system for setting current capacity of a charging cable for supply of battery power from one electric vehicle to another electric vehicle, according to an embodiment of the present disclosure. FIG. 2 is a diagram illustrating a circuit configuration of a system for setting current capacity of a charging cable for supply of battery power from one electric vehicle to another electric vehicle, according to an embodiment of the present disclosure.

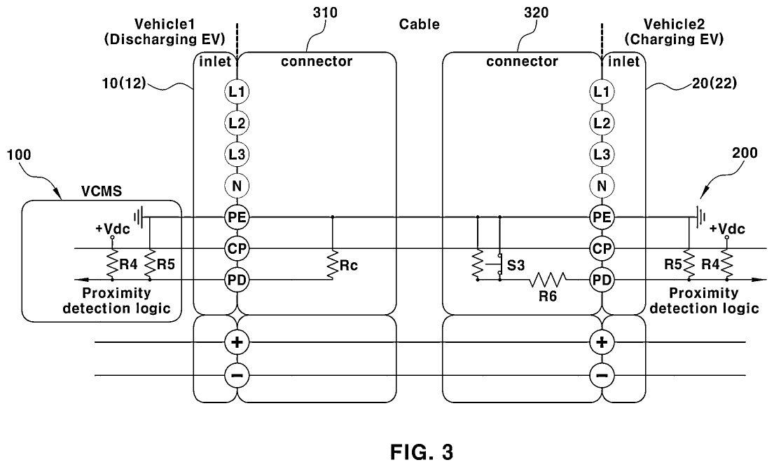

FIG. 3 is a diagram illustrating a circuit configuration of a system for setting current capacity of a charging cable for supply of battery power from one electric vehicle to another electric vehicle, according to another embodiment of the present disclosure.

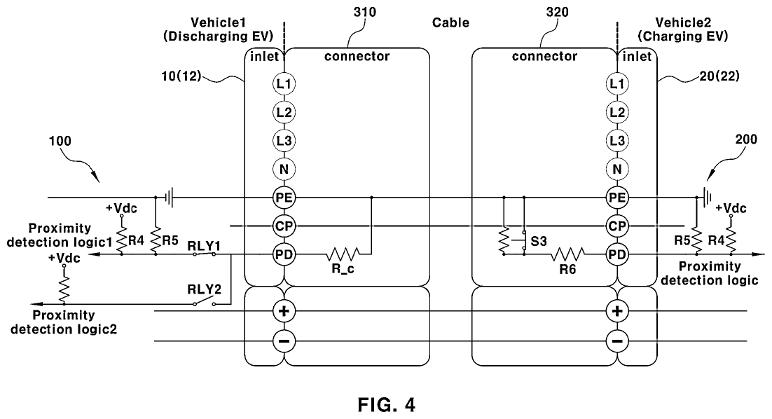

FIG. 4 is a diagram illustrating a circuit configuration of a system for setting current capacity of a charging cable for supply of battery power from one electric vehicle to another electric vehicle, according to yet another embodiment of the present disclosure.

As illustrated in FIG. 1, a system for setting current capacity of a charging cable for supply of battery power from one electric vehicle to another electric vehicle includes a discharge controller 100, a charge controller 200, and a charging cable part 300.

The discharge controller 100 is provided in a supply vehicle 10. The discharge controller 100 controls a battery of the supply vehicle 10 to discharge to supply battery power to a target vehicle 20.

In addition, the charge controller 200 is provided in the target vehicle 20. The charge controller 200 controls a battery of the target vehicle 20 to be charged with battery power supplied from the supply vehicle 10.

Although it has been described that the discharge controller 100 is provided in the supply vehicle 10 and the charge controller 200 is provided in the target vehicle 20, a vehicle having a battery may be equally provided with a single charge-discharge controller such that control for charging or discharging may be selectively performed for vehicles connected through the charging cable part 300.

The charging cable part 300 electrically connects the supply vehicle 10 and the target vehicle 20. The charging cable part includes a first connector 310, a second connector 320, and a connection cable 330.

The first connector 310 forms one portion of the charging cable part 300, and is connected to an inlet 12 of the supply vehicle 10. The second connector 320 forms the other portion of the charging cable part 300, and is connected to an inlet 22.

The connection cable 330 connects the first connector 310 and the second connector 320 to each other such that battery power supplied from the supply vehicle 10 may be supplied to the target vehicle 20 to charge the target vehicle 20.

When battery power is supplied from one typical electric vehicle to another in the related art, a charging cable having a manual setting function or a fixed current capacity is required to be used since there is no function to separately set the charging current of the charging cable.

In other words, in the related art, it is only possible to detect and determine whether the charging cable is connected to the supply vehicle and the target vehicle, but it is not possible to determine current capacity of the charging cable. Accordingly, in conventional systems, a charging cable having maximum current capacity is typically used.

Generally, when a charging operation is performed with a charging current greater than the allowable charging current of the charging cable, there is inevitably a risk of fire. When the charging current is manually set, a user may accidentally input a current greater than an allowable charging current. This situation is inevitably exposed to a risk of fire.

In this regard, when the user uses a charging cable having maximum capacity regardless of allowable charging current capacity of the charging cable, there may be no risk of fire. However, with increases in the weight of the charging cable, the vehicle may also be heavier. In addition, the charging cable may be more expensive. For users who do not want fast charging with high current capacity, it may be impossible to choose an inexpensive and lightweight charging cable having small charging capacity. Thus, the user's desire to purchase a charging cable for supply of battery power from one electric vehicle to another electric vehicle may be reduced.

Accordingly, the discharge controller 100 according to embodiments of the present disclosure may perform control so that the charging current of the charging cable part 300 is set by detecting the allowable charging current of the charging cable part 300 connected to the supply vehicle 10 and by comparing the allowable charging current with a predetermined maximum current outputtable from the supply vehicle 10.

As an example of a circuit configuration, as illustrated in FIG. 2, in a charging system configured to selectively support slow or fast charging, a proximity detection (PD) circuit (or logic) is configured to determine whether or not a charging cable is connected. Resistors Rc having a resistance corresponding to current capacity of the charging cable part 300 are inserted into the first connector 310 and the second connector 320 of the charging cable part 300, respectively, in order to measure a voltage V_pd=Vdc*Rc/(R_pullup+Rc) applied to a resistor Rc of the supply vehicle 10 by the discharge controller 100 and detect current capacity of the charging cable part 300 using the measured voltage V_pd.

In other words, the discharge controller 100 performs control so that a smaller one of the allowable charging current of the charging cable part 300 connected to the inlet 12 and the predetermined maximum current outputtable from the supply vehicle 10 is set as a discharging current. In this regard, since the maximum current is a value stored in advance in accordance with the specification of the battery provided in the supply vehicle 10, the allowable charging current for comparison with the maximum current is calculated using the measured voltage values as described above.

TABLE 1

| V_pd | V_pd_min | V_pd_max | I_dc_max_cable |
|---|---|---|---|
| V_pd1 [V] | V_pd1_min [V] | V_pd1_max [V] | 50 [A] |
| V_pd2 [V] | V_pd2_min [V] | V_pd2_max [V] | 100 [A] |
| V_pd3 [V] | V_pd3_min [V] | V_pd3_max [V] | 150 [A] |
| V_pd4 [V] | V_pd4_min [V] | V_pd4_max [V] | 200 [A] |
| . | . | . | . |
| . | . | . | . |
| . | . | . | . |

More specifically, when a transmitted signal, such as a switch signal for fast charging transmitted by the user or a fast charging activation is transmitted through an in-vehicle screen, is received by the discharge controller 100, the voltage V_pd=Vdc*Rc/(R_pullup+Rc) applied to the resistor Rc inserted into the first connector 310 is measured and applied to an output table such as Table 1. The measured voltage is included in a voltage range among a plurality of different minimum and maximum voltage ranges from a voltage range from V_pd1_min[V] to V_pd1_max[V] to a voltage range from V_pd4_min[V] to V_pd4_max[V] Thus, conversion into an allowable charging current such as 50A, 100A, 150A, or 200A may be performed.

The allowable charging current according to a plurality of different minimum measured voltage ranges and a plurality of different maximum voltage ranges, converted differently according to slow charging or fast charging, may be stored in the output table such as Table 1. When fast charging is selected in response to a user input, the discharge controller 100 may apply the measured voltage to the corresponding output table and compare the allowable charging current converted according to the measured voltage with the maximum current.

Consequently, the discharge controller 100 may perform control by comparing the maximum current outputtable from the supply vehicle 10 and the allowable charging current of the charging cable part 300 so that the discharging current is limited to a smaller one of the maximum current and the allowable charging current. Unlike in the related art, even when a charging cable having an intended amount of current capacity is selected instead of a charging cable having maximum current capacity, current capacity for charging of the charging cable part 300 may be automatically detected and output may be controlled. Accordingly, it may be possible to prevent the user from accidentally entering a wrong value of current capacity, thereby improving the safety of charging and providing convenience.

In addition, the problem of the related art that reduces consumer's desire to purchase a charging cable due to excessive price and weight of the charging cable having maximum current capacity that must be selected for fire prevention may be overcome. The inexpensive and lightweight charging cable having small charging capacity may be selected.

According to an embodiment, in the PD circuit configuration for viewing whether or not the charging cable configured is connected as illustrated in FIG. 3, a voltage V_pd=Vdc*(Rc*R5)/(Rc+R5)/(R4+((Rc*R5)/(Rc+R5)) may be measured using a known circuit in which the register Rc corresponding to current capacity of the charging cable part 300 is selectively inserted into the first connector 310 of the charging cable part 300 and the resistor Rc is not inserted into the second connector 320. Then, current capacity of the charging cable part 300 may be detected using the measured voltage V_pd.

As in the above embodiment, when a transmitted signal, such as a switch signal for fast charging transmitted by the user or a fast charging activation is transmitted through an in-vehicle screen, is received by the discharge controller 100, the voltage V_pd=Vdc*(Rc*R5)/(Rc+R5)/(R4+((Rc*R5)/(Rc+R5)) applied to the resistor Rc inserted into the first connector 310 is measured and applied to an output table such as Table 1. The measured voltage is included in a voltage range among a plurality of different minimum and maximum voltage ranges from a voltage range from V_pd1_min[V] to V_pd1_max[V] to a voltage range from V_pd4_min[V] to V_pd4 max [V]. Thus, conversion into an allowable charging current such as 50A, 100A, 150A, or 200A may be performed.

In this manner, the discharge controller 100 may apply the measured voltage to the corresponding output table and compare the allowable charging current converted according to the measured voltage with the maximum current. Consequently, the discharge controller 100 may perform control so that the discharging current is limited to a smaller one of the allowable charging current and the maximum current. Even when a charging cable having an intended amount of current capacity is selected instead of a charging cable having maximum current capacity, current capacity for charging of the charging cable part 300 may be detected and output may be controlled. Accordingly, it is possible to improve the safety of charging and provide convenience.

According to another embodiment, as illustrated in FIG. 4, a circuit configuration including two circuits and two relays is provided in the supply vehicle 10. The two circuits are PD circuit 1 and PD circuit 2, and the relays are relays RLY1 and RLY2 configured to convert the PD circuit 1 and the PD circuit 2. The relay RLY1 operates in an on state, while the relay RLY2 operates in an off state. When there is an activation signal of the discharge controller 100 for charging of the target vehicle 20, the relays RLY1 and RLY2 operate in an opposite manner, i.e., the relay RLY1 operates in an off state and the relay RLY2 operates in an on state.

When the relay RLY1 is turned off and the relay RLY2 is turned on as described above, a voltage V_pd=Vdc*Rc/(R_pullup+Rc) applied to the register Rc of the supply vehicle 10 may be measured by the discharge controller 100 and current capacity of the charging cable part 300 may be detected using the measured voltage V_pd.

More specifically, when fast charging is selected in response to a user input, the relay RLY1 and the relay RLY2 are switched from the on state and the off state to the off state and the on state, respectively. A voltage V_pd=Vdc*Rc/(R_pullup+Rc) applied to the resistor Rc inserted into the first connector 310 is then measured and applied to the output table. Since the measured voltage is included in a voltage range among a plurality of different minimum and maximum voltage ranges from a voltage range from V_pd1_min[V] to V_pd1_max[V] to a voltage range from V_pd4_min[V] to V_pd4_max[V], the voltage is converted into an allowable charging current such as 50A, 100A, 150A, or 200A (see Table 1 above). The converted allowable charging current is compared with a maximum current.

Consequently, the discharge controller 100 may perform control by comparing the maximum current outputtable from the supply vehicle 10 and the allowable charging current of the charging cable part 300 so that the discharging current is limited to a smaller amount of current. Unlike in the related art, even when a charging cable having an intended amount of current capacity is selected instead of a charging cable having maximum current capacity, current capacity for charging of the charging cable part 300 may be detected and output may be controlled. Accordingly, it is possible to improve the safety of charging and provide convenience.

In addition to embodiments described above, the discharge controller 100 may be used in a charging system including a variety of PD circuit configurations. In various embodiments, the discharge controller 100 may obtain the same effects as in the above-described embodiments by measuring a voltage, converting the voltage into an allowable current, comparing the converted allowable current with a maximum current, and performing control so that the discharging current is limited to a smaller one of the allowable current and the maximum current.

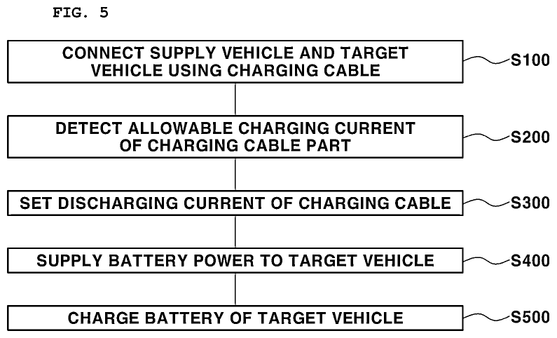

FIG. 5 is a flowchart illustrating a method of setting current capacity of a charging cable for supply of battery power from one electric vehicle to another electric vehicle, according to embodiments of the present disclosure.

The method of setting current capacity of a charging cable for supply of battery power from one electric vehicle to another electric vehicle according to an embodiment is sequentially illustrated in FIG. 5.

In an operation S100, The supply vehicle 10 intended to supply battery power and the target vehicle 20 intended to receive battery power are electrically connected through the charging cable part 300.

In an operation S200, as the charging cable part 300 is connected to the supply vehicle 10, the allowable charging current of the charging cable part 300 connected to the supply vehicle 10 through the discharge controller 100 is detected.

The allowable charging current may be detected as follows, according to an embodiment. When a transmitted signal, such as a switch signal for fast charging transmitted by the user or a fast charging activation is transmitted through an in-vehicle screen, is received by the discharge controller 100, the voltage V_pd=Vdc*Rc/(R_pullup+Rc) applied to the resistor Rc inserted into the first connector 310 is measured and applied to an output table (see Table 1 above), as illustrated in FIG. 2. The measured voltage is included in a voltage range among different minimum and maximum voltage ranges. Thus, the voltage may be converted into an allowable charging current such as 50A, 100A, 150A, or 200A.

Then, in an operation S300, the discharging current of the charging cable part 300 is set by comparing the allowable charging current converted and the predetermined maximum current outputtable from the supply vehicle 10 by the discharge controller 100.

The discharge controller 100 sets the discharging current for charging to be limited to a smaller one of the allowable charging current and the maximum current. When the charging operation is performed with a charging current greater than the allowable charging current of the charging cable part 300, there is inevitably a risk of fire. In addition, when the charging current is manually set, a user may accidentally input a current greater than the allowable charging current. This situation is inevitably exposed to a risk of fire. In an embodiment, the discharge controller 100 performs control by comparing the allowable charging current and the maximum current so that a lower one of the allowable charging current and the maximum current is set as the discharging current of the charging cable part 300. In this manner, a risk of fire as described above may be prevented.

In an operation S400, control is performed to supply battery power to the target vehicle 20 by discharging the battery of the supply vehicle 10 according to the discharging current calculated by comparing the allowable charging current and the maximum current. In an operation S500, the battery of the target vehicle 20 is charged using battery power of the discharging current supplied from the supply vehicle 10.

As a result, according to embodiments of the present disclosure, even when a charging cable having an intended amount of current capacity is selected instead of a charging cable having maximum current capacity as in the related art, current capacity for charging of the charging cable part 300 may be detected and output may be controlled. Accordingly, it is possible to improve the safety of charging and provide convenience. In addition, the problem of the related art that reduces consumer's desire to purchase a charging cable due to excessive price and weight of the charging cable having maximum current capacity that must be selected for fire prevention may be overcome.

According to embodiments of the present disclosure, control is performed by comparing the maximum current outputtable from the supply vehicle and the allowable charging current of a charging cable part calculated during slow or fast charging so that the discharging current is limited to a smaller one of the maximum current and the allowable charging current. Thus, the current capacity of the charging cable may be appropriately limited. During the supply of battery power from one electric vehicle to another electric vehicle, a fire or the like may be prevented, thereby improving safety. In addition, it is not required to manually set current capacity of the charging cable. Accordingly, convenience may be provided.

Accordingly, according to embodiments of the present disclosure, it is not necessary to use a charging cable having the maximum discharge current for safety reasons, and there is an effect of allowing consumers to select a charging cable having desired current capacity in consideration of weight, price, and the like of the charging cable.

In addition, embodiments of the present disclosure provide convenience because charging control is performed by determining the allowable current capacity of the charging cable connected to the supply vehicle and by comparing the allowable current capacity with the allowable current of the charging cable.

Although the present disclosure has been described with reference to the embodiments and the accompanying drawings, it should be apparent to those having ordinary skill in the art that the embodiments are provided for illustrative purposes only, and that various modifications and alterations can be made without departing from the spirit and scope of the present disclosure. It should also be understood that the entirety or some of the foregoing embodiments may be selectively combined. Accordingly, the true scope and spirit of the present disclosure shall be defined only by the appended claims.

What is claimed is:

1. A system for setting current capacity of a charging cable for supply of battery power from one electric vehicle to another electric vehicle, the system comprising:
a discharge controller provided in a supply vehicle to discharge a battery of the supply vehicle to supply battery power to a target vehicle;
a charge controller provided in the target vehicle to charge a battery of the target vehicle with battery power supplied from the supply vehicle; and
a charging cable part configured to electrically connect the supply vehicle and the target vehicle,
wherein the discharge controller is configured to perform control so that a discharging current of the charging cable part is set by detecting an allowable charging current of the charging cable part connected to the supply vehicle and comparing the allowable charging current with a predetermined maximum current outputtable from the supply vehicle.

2. The system according to claim 1, wherein the discharge controller is configured to perform control so that a smaller one among the allowable charging current and the maximum current is set as the discharging current.

3. The system according to claim 1, wherein the discharge controller is configured to:
measure a voltage applied to a resistor inserted into a first connector of the charging cable part connected to the supply vehicle, and
detect the allowable charging current using the measured voltage.

4. The system according to claim 3, wherein the discharge controller is configured to:
apply the measured voltage to an output table including a plurality of minimum voltage ranges and a plurality of maximum voltage ranges, and
compare the allowable charging current converted according to the measured voltage with the maximum current.

5. The system according to claim 4, wherein the allowable charging current according to the plurality of minimum and maximum voltage ranges is converted and stored in the output table.

6. The system according to claim 5, wherein the allowable charging current according to the measured voltage, converted differently according to slow charging or fast charging, is stored in the output table, and
the discharge controller is configured to, when fast charging is selected in response to a user input, apply the measured voltage to a corresponding output table and compare the allowable charging current converted according to the measured voltage with the maximum current.

7. The system according to claim 1, wherein the charging cable part comprises:
a first connector connected to an inlet of the supply vehicle;
a second connector connected to an inlet of the target vehicle; and
a connection cable connecting the first connector and the second connector to each other.

8. A system for setting current capacity of a charging cable for supply of battery power from one electric vehicle to another electric vehicle, the system comprising:
a charging cable part comprising a first connector for discharging of a battery and a second connector for charging of the battery, the charging cable part configured to electrically connect vehicles; and
a charge-discharge controller configured to perform control so that a discharging current of the charging cable part to be supplied through the second connector is set by i) detecting an allowable charging current of the charging cable part connected to the first connector and ii) comparing the allowable charging current with a predetermined maximum current outputtable from the first connector.

9. The system according to claim 8, wherein the charge-discharge controller is configured to set the discharging current to be limited to a smaller one among the allowable charging current and the maximum current.

10. The system according to claim 8, wherein the charge-discharge controller and the battery are provided in each of the vehicles.

11. The system according to claim 8, wherein:
the charging cable part is configured such that a resistor is selectively inserted into the first connector, and
the charge-discharge controller is configured to measure a voltage applied to the resistor inserted into the first connector and detect the allowable charging current through the measured voltage.

12. A method of setting current capacity of a charging cable for supply of battery power from one electric vehicle to another electric vehicle, the method comprising:
electrically connecting a supply vehicle to supply battery power and a target vehicle to receive the battery power using a charging cable part;
when the charging cable part is connected to the supply vehicle, detecting, by a discharging controller, an allowable charging current of the charging cable part connected to the supply vehicle;
setting a discharging current of the charging cable part by comparing, by the discharging controller, the allowable charging current and a predetermined maximum current outputtable from the supply vehicle;
discharging a battery of the supply vehicle according to the discharging current to supply the battery power to the target vehicle; and
charging the battery of the target vehicle using the battery power of the discharging current supplied from the supply vehicle.

13. The method according to claim 12, wherein, setting the discharging current of the charging cable part includes setting, by the discharging controller, the discharging current to be limited to a smaller one of the allowable charging current and the maximum current.

14. The method according to claim 12, wherein, setting the discharging current of the charging cable part includes:
measuring, by the discharging controller, a voltage applied to a first connector of the charging cable part connected to the supply vehicle, and
detecting, by the discharging controller, the allowable charging current through the measured voltage.

15. The method according to claim 14, wherein, setting the discharging current of the charging cable part includes:
applying, by the discharging controller, the measured voltage to an output table including a plurality of minimum voltage ranges and a plurality of maximum voltage ranges, and
comparing the allowable charging current converted according to the measured voltage with the maximum current.

16. The method according to claim 15, wherein the allowable charging current according to the plurality of minimum and maximum voltage ranges is converted and stored in the output table.

17. The method according to claim 16, wherein the allowable charging current according to the measured voltage, converted differently according to slow charging or fast charging, is stored in the output table, and
setting the discharging current of the charging cable part includes, when fast charging is selected in response to a user input,
applying, by the discharging controller, the measured voltage to a corresponding output table, and
comparing, by the discharging controller, the allowable charging current converted according to the measured voltage with the maximum current.
